(19) United States
(12) Patent Application Publication
(10) Pub. No.: US 2019/0057594 A1
(43) Pub. Date: Feb. 21, 2019

(54) OCCUPANCY OR VACANCY INDICATING SYSTEM

(71) Applicant: EVACMATE PTY LTD, St. Lucia (AU)

(72) Inventors: Marcel Xavier LELIEVRE, Red Hill (AU); Megan Louise LELIEVRE, Red Hill (AU); Seppo SAARIO, Red Hill (AU); Ray DIMARCO, Red Hill (AU); Matheus Cavalca RUGGIERO, Red Hill (AU)

(73) Assignee: EVACMATE PTY LTD, St. Lucia (AU)

(21) Appl. No.: 15/770,488

(22) PCT Filed: Oct. 20, 2016
(86) PCT No.: PCT/AU2016/050986

§ 371 Date: Apr. 23, 2018

(30) Foreign Application Priority Data
Oct. 23, 2015 (AU) 2015904358

(51) Int. Cl. G08B 21/22; G08B 5/22; G08B 25/10; G08B 7/06; H04W 4/021; H04L 29/12

(52) U.S. Cl. CPC G08B 21/22; G08B 5/221; G08B 25/10; H04W 4/80; H04W 4/021; H04L 61/6068; H04L 61/6022; G08B 7/06

(57) ABSTRACT

An occupancy or vacancy indicating system comprising: one or more indicating modules for indicating occupancy or vacancy of one or more areas of a space; and a setting means for setting a status of the indication modules, the status being indicative of the occupancy or vacancy of said one or more areas, wherein the setting means is operable for setting the status of indicating modules from a remote location relative to the one or more areas by transmitting one or more signals to the indicating module sensing means for sensing an indication of occupancy or vacancy, as indicated by a user during use in the one or more areas.

### TECHNICAL FIELD

The present invention relates generally to an occupancy or vacancy indicating system.

### BACKGROUND ART

Emergency situations in buildings pose several challenges for emergency personnel. An important step during such a situation is to safely track vacancy or occupancy of a building. An increase of multi-storied buildings in cities around the world has exacerbated the problem of tracking occupancy or vacancy of buildings in a safe and efficient manner during emergencies. In some emergencies such as a fire, the building may need to be safely evacuated. In other emergencies, such as an impending terrorism threat, the building may need to be locked down until the situation returns to normal.

The prior art indicating methods and systems for buildings typically involve the announcement of an alert via a PA system. In many instances, an alarm is also used for warning and directing building occupants of each floor to proceed to the nearest exit, in an orderly manner, as previously rehearsed during emergency drills. In at least some buildings, one or more building occupants are designated evacuation or fire wardens. A warden is assigned to each floor for conducting the evacuation proceedings. When the last occupant leaves the floor, a respective evacuation warden calls the command center by using an emergency telephone to report on the status of the evacuation.

In currently known systems, the warden must initially inspect each area or zone on his or her designated floor before informing the command centre via the emergency telephone. Inspection is time consuming and does not provide real time indication or data in relation to the vacancy status of each area of the designated floor. Furthermore, another person at the command centre is required for receiving the phone call from the warden. After receiving the phone call, the person at the command center typically acknowledges and records the vacancy status of the designated floor before activating an alarm for the building.

During times of emergency, the emergency telephone system may become overloaded as many evacuation wardens may attempt to reach the command center at the same time. Excessive time may elapse in requesting assistance of an emergency response team and may jeopardize the hives of building occupants and the warden. During such an emergency, it is also important to ensure that the designated floor has been evacuated before emergency personnel can commence with fire mitigation operations such as using water cannons. Commencing fire mitigation operations in a specific section or area of a building without properly evacuating the building has the potential of seriously injuring building occupants. Therefore, there exists a need for an improved fire evacuation indication system that is less time consuming and more efficient in indicating a vacant status of an area in a given space such as a building.

In some other prior art systems, remotely monitored smoke and fire detectors are provided across various areas of a building. Such detectors are able to monitor and report parameters such as temperature, smoke and heat from one or more areas of a building. However, such detectors fail to indicate whether a building is vacant or has been evacuated. As a result, a person such as a warden is required to physically inspect different areas of the building to confirm that these areas are vacant before commencing mitigation operations, as suggested earlier.

Furthermore, the use of smoke and fire detectors may also give rise to false alarms and may require emergency personnel to locate the faulty or false alarm and reset the false alarm. Locating the faulty monitor or alarm and resetting the individual monitors or alarms can be a time consuming and arduous process for emergency personnel. Therefore, there exists a need for an evacuation system and method that may overcome the above, as well as other, disadvantages of the conventional systems.

It will be clearly understood that, if a prior art publication is referred to herein, this reference does not constitute an admission that the publication forms part of the common general knowledge in the art in Australia or in any other country.

### SUMMARY OF INVENTION

In one aspect, the invention provides an occupancy or vacancy indicating system comprising: an indicating assembly comprising a controller and an indicator to indicate an occupancy or vacancy related status of one or more areas of a space; the controller being arranged to set the status of the indicator; a receiver for receiving one or more signals from a remotely located device, the receiver being in communication with the controller to initialise the indicating assembly to thereby indicate an activated status in response to receiving a signal from the remotely located device; and a sensor positioned in close proximity to the indicating assembly, the sensor being in communication with the controller for modifying the display status of the activated indicator upon sensing occupancy or vacancy of the one or more areas of the space.

The provision of the indicating assembly in combination with the controller allows emergency personnel to change the status of the indication modules from the remote location and alleviates the requirement for a person to physically inspect one or more areas of the space.

In an embodiment, the indicator comprises a visual indicating means provided in one or more of the areas. In additional or alternative embodiments, the indicating means may take the form of audible or tactile indicating means. The provision of the indicating means enables wardens or emergency personnel to quickly get an indication of vacancy status in the one or more areas. without necessarily carrying out a thorough inspection of the one or more areas.

In an embodiment, one or more of the indicators comprises sensing means for sensing an indication of occupancy or vacancy, as indicated by a user, in the one or more areas. Preferably, the status of the indicator is adapted to be set in response to the sensing of the indication of occupancy or vacancy by a user in the one or more areas. For example, in a preferred embodiment, the sensing module may comprise a Radio Frequency Identification (RFID) sensor. During an emergency, a warden may inspect a designated area and provide an indication of vacancy of an area by activating the RFID sensor on the indicator located in the area by using their authorised RFID card. In alternative embodiments, the sensing module may comprise a Bluetooth enabled or Wi-Fi enabled sensor.

In a preferred embodiment, the indicator is operable to indicate a first status and a second status such that that the controller is adapted for switching the indicator between the first status and the second status. In a further preferred embodiment, the status for indicator may be set to the first or second status, in response to the sensing of the indication of occupancy or vacancy. For example, a person inspecting the one or more area, upon clearing or evacuating the area, may switch the status from the first status to a second status on the indicator. In an embodiment, the controller is adapted for switching the indicating module between the first status and the second status in response to the sensing of the indication of occupancy or vacancy and/or in response to receiving a signal from the remotely located device.

In an embodiment, the controller may comprise a setting device adapted to be remotely located relative to the one or more areas, said setting device being provided with input means for receiving user input for setting the status of the indicator from a remote location. The setting device allows remotely located emergency personnel to enter user input on the setting device and thereby set the status of the indicator.

In an embodiment, the controller may be adapted for controlling a locking mechanism located in the one or more areas. Controlling the locking mechanism by using the controller allows lockable devices such as a door lock or lock for a fire panel to be controlled from a remote location.

In a further embodiment, the sensing means may be further adapted for detecting variations in environmental or building parameters in the one or more areas. For example, the sensing means may have the ability to sense one or more of the following parameters: acoustic, sound, vibration, chemical, electrical current, electric potential, magnetic parameters, flow parameters, ionizing, radiation, subatomic particles, photons, pressure, force, density, heat, temperature, and proximity or presence.

In an embodiment, the indicator is operable to indicate a first status and a second status such that that the controller is adapted for switching the indicator between the first status and the second status. Preferably, the status for indicator is operable to be set to the first or the second status, in response to the sensing of the indication of occupancy or vacancy.

In an embodiment, the system further comprises a processing module for receiving information relating to occupancy or vacancy of the one or more areas from the indicators over a network and processing the information for display at a remote location. The processing module assists in processing the occupancy or vacancy related information in a useful manner and displays the information on a displaying device located remotely from the one or more areas. By way of example, the information may be displayed on a graphical user interface (GUI) provided on the displaying device.

In some preferred embodiments, the information, as received by the processing module, may be overlaid or combined with additional data or information (such as mapping data) for being displayed on the displaying device. Overlaying or combining the information with additional data and processing of the information in the processing module, as described herein, allows the system to generate useful information.

In further preferred embodiments, the vacancy related information may be stored on storage means such as cloud based data storage devices. The storage of the information allows retrieval of the information at a later date for purposes such as preparing reports or audits relating to an emergency situation. The storage of the information also allows for retrospective and real time processing of information. An algorithm may be provided for one or more applications for generating predictive information based upon the status of the indicator. As previously described, the bi-directional capability of the present system allows a remotely located user to send control information from a remote location and the status of the indicator may be subsequently changed if need be.

In an embodiment, the system comprises a central access gateway and one or more radio nodes adapted for connecting one or more indicators located near the one or more nodes, wherein the radio nodes are connected to the access gateway across the network and the gateway is adapted for setting the status of the indicators connected to said one or more nodes.

Preferably, each one or more of the indicators is a Wi-Fi enabled device having a unique MAC address associated with each of the indicators for establishing an Internet Protocol (IP) connection with the gateway.

In an embodiment, the access gateway is connected to a server, preferably a remotely located server, the access gateway being adapted for receiving setting instructions from the server.

In an embodiment, the system further comprises a processor configured to run a module stored in a memory, the module being configured to establish an IP connection between the gateway and said one or more nodes across the network, the node being configured to wirelessly connect with the Wi-Fi devices for allowing transmission of data between the indicators and the gateway. Preferably, the module is configured to establish an IP connection between the gateway and said one or more nodes across the network by identifying the MAC address associated with the Wi-Fi devices and associating each of the Wi-Fi devices with one or more corresponding nodes.

In an embodiment, the indicator is adapted for sensing an indication of occupancy or vacancy and displaying a first visual indicia in response to sensing the indication, transmitting the indication to the remote location and wherein the indicator is adapted for displaying a second visual indicia in response to receiving confirmation of the transmission of the indication to the remote location.

Preferably, the indicator is adapted for sensing an indication of occupancy or vacancy and displaying a first visual indicia in response to sensing the indication, transmitting the indication to the gateway and/or the server and wherein the indicator is adapted for displaying a second visual indicia in response to receiving confirmation of the transmission of the indication to the gateway and/or server.

In a second aspect, the invention provides an occupancy or vacancy indicating method comprising the steps of: initialising an indicating assembly from a remote location to display an activated status on an indicator of the indicating assembly by transmitting a signal from the remote location to the indicating assembly; sensing occupancy or vacancy of one or more areas of a space by with a sensor in the one or more areas; and controlling the indicator of the initialised indicating assembly in response to the sensor sensing the occupancy or vacancy in the one or more areas.

In an embodiment, the method further comprises the step of changing the status of the indicator in response to sensing an indication of occupancy or vacancy by a user in the one or more areas.

Preferably, the step of changing the status comprises switching the status from at least a first status relating to occupancy or vacancy of a user in the one or more areas to at least a second status relating to occupancy or vacancy of the user in the one or more areas.

In an embodiment, the method further comprises the step of sensing a Radio Frequency Identification (RFID).

In an embodiment, the method further comprises the step of sensing one or more of the following parameters: sound, vibration, chemical, electrical current, electric potential, magnetic parameters, flow parameters, ionizing, radiation, subatomic particles, photons, pressure, force, density, heat, temperature, and proximity or presence.

In an embodiment, the method further comprises the step of controlling a locking mechanism located in said one or more areas wherein preferably the step of setting the status of the indicator from the remote location also controls the locking mechanism.

In an embodiment, the method further comprises the step of receiving and processing information from the one or more indicators, said information relating to occupancy or vacancy of the one or more areas, and preferably displaying processed information on a display device, the displaying device being preferably located at a remote location.

In an embodiment, the processing step comprises overlaying the received information with additional data or information, for display on the displaying device.

In an embodiment, the method further comprises the step of storing the received information and/or the processed information in a storage medium.

In an embodiment, the method further comprises the steps of establishing, by an access gateway, an Internet Protocol (IP) connection between a plurality of nodes, across a network and the gateway, said nodes adapted for connecting with one or more indicators located near said one or more nodes; and setting the status of the indicators connected to said one or more nodes by transmitting one or more signals from the gateway to said one or more nodes.

In an embodiment, each one or more of the indicators is a Wi-Fi enabled device having a unique MAC address, the method further comprising the step of associating each one or more Wi-Fi enabled devices with one or more of the indicators and establishing an Internet Protocol (IP) connection with the gateway.

In an embodiment, the method further comprises the steps of: connecting the access gateway to a server, preferably a remotely located server, and transmitting instructions from the server to the access gateway, the instructions being provided for setting the status of the indication modules.

In an embodiment, the method further comprises the steps of: providing a sensing means in the indicator and sensing an indication of occupancy or vacancy and displaying a first visual indicia in response to sensing the indication, transmitting the indication to the gateway and/or the server and wherein the indicator and displaying a second visual indicia in response to receiving confirmation of the transmission of the indication to the gateway and/or server.

In an embodiment, the indicator is adapted for sensing an indication of occupancy or vacancy and displaying a first visual indicia in response to sensing the indication, transmitting the indication to the remote location and wherein the indicator is adapted for displaying a second visual indicia in response to receiving confirmation of the transmission of the indication to the remote location.

In some embodiments, the indicators maybe inter-connected with each other over a connecting network for allowing transfer of information between the indicators. Interconnecting the indication modules provides multiple pathways for sending and receiving information between the one or more indicators and the processing module.

The present disclosure allows occupancy or vacancy related information to be indicated during evacuation of spaces such as a building. Advantageously, the disclosure also allows occupancy related information to be indicated during periods of lockdown of spaces such as a building.

In another aspect, the invention provides a device for indicating an occupancy or vacancy status of a designated area, the device comprising: a microcontroller, a memory accessible by the microcontroller and a data port assembly in communication with the microcontroller for establishing a connection with an access gateway, the memory including executable instructions for operating the microcontroller in an activated mode upon receiving an activation signal from the access gateway; a switching device in communication with the microcontroller for switching the status of the activated microcontroller in between at least a first occupancy or vacancy status and a second occupancy or vacancy status when the microcontroller is operating in the at least one operable mode; and one or more indicators for indicating said at least first and/or second status during use.

In an embodiment, the microcontroller comprises a wireless transreceiver for wirelessly communicating with the gateway wherein the gateway is located remotely from the transreceiver.

In an embodiment, the device comprises an RFID circuit, the RFID circuit including an antenna and a control circuit coupled to the antenna, the circuit configured to toggle between at least a first function corresponding to a first status and at least a second function corresponding to a second status.

In an embodiment, said one or more indicators comprises visual indicia, preferably indicating lights.

In yet another aspect, the invention provides a computer server for implementing an occupancy or vacancy indicating system, the server comprising: a processor; a computer readable medium in communication with the processor; a data communications port, wherein the computer readable medium comprises executable instructions to: establish a connection for transmission of data between the data communications port and a remotely located access gateway and communicate with a remotely located microcontroller by transmitting data packets, said microcontroller being in communication with the gateway; check for a response from the gateway, the response being in relation to a status recorded by a sensor in communication with the remotely located microcontroller; and transmit data packets from the data communications port to the microcontroller upon receiving the response.

### BRIEF DESCRIPTION OF DRAWINGS

Various embodiments of the invention will be described with reference to the following drawings, in which:

FIG. 1 is a block diagram of an occupancy or vacancy indicating system 1000 in accordance with an embodiment of the present invention.

FIG. 2 is a frontal view of the indicator 20.

FIG. 3 is a block diagram for the indicator 20.

FIG. 4 is a block diagram for a remotely located server 500 in accordance with another embodiment of the present invention.

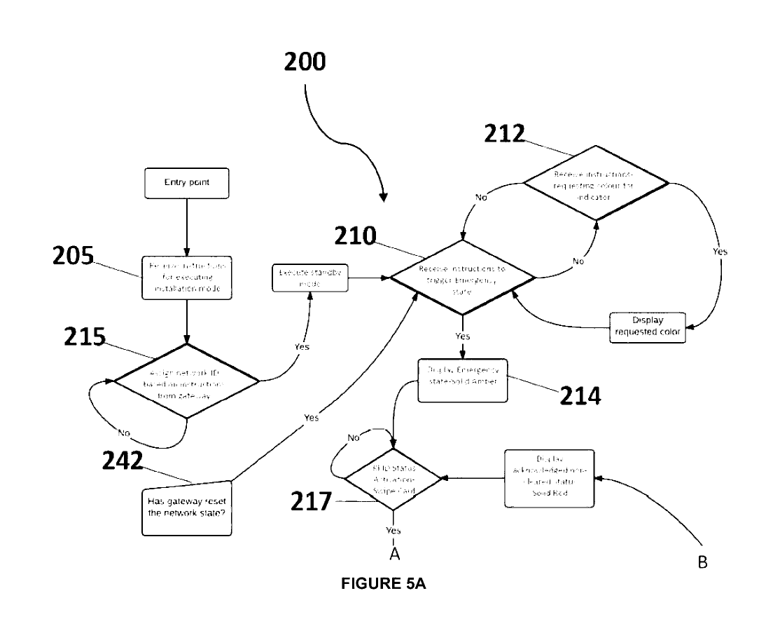

FIGS. 5A and 5B depict a flowchart of a process to be executed by the indicator 20.

FIG. 6 is a flowchart of a process to be executed by the remotely located server 500.

FIG. 7 is a block diagram of the occupancy or indicating system 1000 during use.

### DESCRIPTION OF EMBODIMENTS

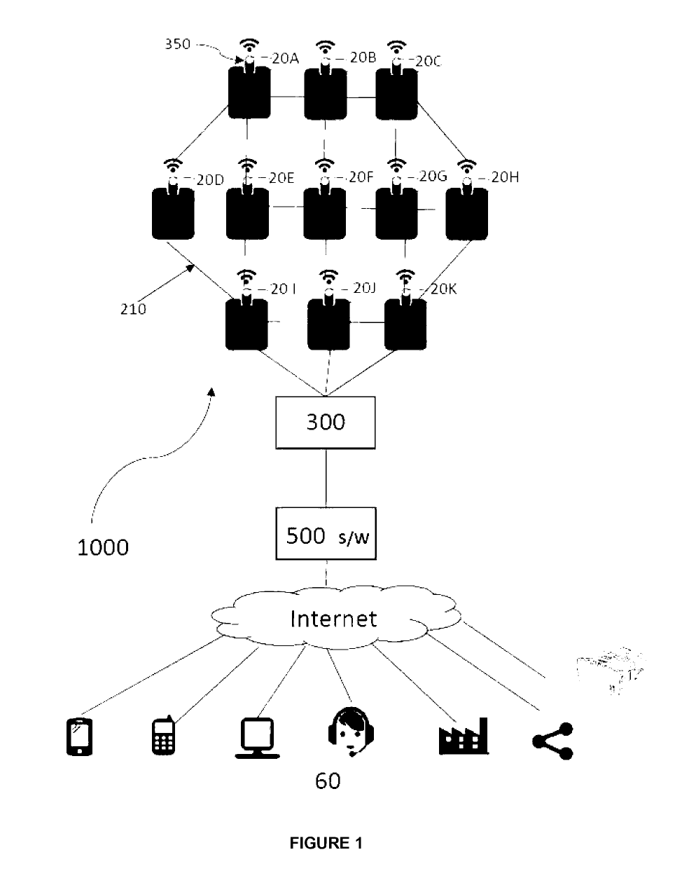

FIG. 1 depicts a block diagram for an evacuation indicating system 1000 in accordance with a preferred system embodiment of the invention. The system 1000 comprises eleven indication modules 20A to 20K that are inter-connected in a mesh network and adapted for indicating vacancy in one or more areas of a space such as a building. The indication modules 20A to 20K can be located at various areas or zones of the building. The indicators are provided in a mountable configuration for allowing convenient mounting of the indicator 20 on surfaces such as a wall of a building. In the present embodiment, the occupancy indicating system requires a central access gateway 300 and a plurality of radio nodes 350 adapted for connecting the one or more indicators located near the one or more nodes. Specifically, each of the indicators 20A to 20K includes a Wi-Fi enabled device having a unique MAC address associated with each of the indicators 20A to 20K for establishing an Internet Protocol (IP) connection with the gateway 300. The radio nodes 350 are connected to the access gateway 300 across the network and during use and the gateway 300 is adapted for setting the status of the indicators 20 connected to the nodes 350. In the preferred embodiment, each of the indicators 20 includes a Wi-Fi enabled device having a unique MAC address associated with each of the indicators 20 for establishing an Internet Protocol (IP) connection with the gateway 350. The access gateway 300 is also connected to a remotely located server 500. During use, the access gateway 350 is configured for receiving setting instructions from the server 500 and allows setting instructions to be sent to one or more of the nodes 350 in order to set the status of the indicators 20 during use. In the preferred embodiment, the gateway 300 and the remote server 500 are interconnected by a wired connection. On the other hand, the plurality of nodes 350 are inter-connected with each other and also connected to the gateway by way of Wi-Fi as previously discussed. The nodes 350 are also inter-connected with each other thereby forming a mesh network. As previously discussed, providing the nodes 350 in a mesh network allows information to be shared between the indicators 20A to 20K.

During use, the indicators 20 are adapted to be initialised to an operative state during an emergency by receiving instructions from the remote server 500. Similarly, the indicators 20 are also adapted to be returned to a non-initialised state when there are no emergency events. Specifically, the remote server 500 may send initialisation instructions to the indicators 20A to 20K to trigger an activated or active state in the indicators 20A to 20K. Once an activated state is triggered, the indicators 20A to 20K may also display an indication of the activated state. Each of the indicators 20A to 20K also include a switch provided in the form of an RFID sensor that is built into the body of the indicators 20A to 20K. During use, an authorised RFID tag reader may be used by emergency personnel to activate and display various occupancy states. By way of example, once a designated area associated with an indicator 20 has been physically inspected by a floor warden, the floor warden may use their authorised RFID tag for swiping their tag on the sensor and activating an unoccupied state on the indicator 20 resulting in the indicator 20 displaying an indication (LED lights in a first colour) that the designated area is vacant or unoccupied. Similarly, if the designated area has not been cleared or vacated then the authorised personnel may use their RFID tag for activating and triggering an occupied state in the indicator 20 which results in the indicator 20 displaying an indication (LED lights in a second colour) that the designated are is occupied or non-vacant.

The indicators 20 may be initialised by remotely located devices or personnel 60. Specifically, the remotely located personnel may provide initialisation instructions on user input of a computing device that is connected to the remotely located severer 500 via a network such as the internet. The server 500 may process the initialisation instructions and direct the initialisation instructions in the form of data packets to the indicators 20A to 20K via gateway 300. The detailed working of the server 500 and the indicators 20 has been described in the foregoing sections.

The indicators 20, once initialised, are adapted for indicating a “vacant” status and a “non-vacant” status, as previously described. In the preferred embodiment, the vacancy status is displayed on the indicator 20 by visual indicating means 22. The visual indicating means 22 take the faun of LED lights that glow in pre-defined colours indicative of the “vacant” and “non-vacant” status. In alternative embodiments, audible indicating means such as a speaker broadcasting a pre-recorded audible message may also be provided to indicate the status on the indicators 20.

During use of the indicator 20 in the initialised state, the status of the indicator 20 is settable by the setting switch 30. Specifically, as previously described the setting switch 30 allows a user such as a floor warden to inspect a relevant area and set the status to the “vacant” or the “non-vacant” state depending on whether the relevant area has been vacated. The setting switch 30 in the preferred embodiment comprises an RFID sensing device. The inspecting person is able to set the status of the indicator to the vacant or non-vacant status by activating the RFID sensor using their authorised RFID card. Whilst, the preferred embodiment demonstrates the use of an RFID sensing system for setting the status on the indicating, a skilled person may use alternative technologies such as infra-red, Bluetooth or other electronic signalling means for setting the status of the indicators 20. The setting switch 30 also allows remotely located users to set the status of indicators as described in previous sections. The working of the setting switch 30 in conjunction with the remotely server 500 has been discussed in further detail in the subsequent sections.

The indicator 20 can be further improved by providing sensors adapted for detecting variations in environmental or building parameters in the one or more areas. The sensing means may have the ability to sense one or more of the following parameters: acoustic, sound, vibration, chemical, electrical current, electric potential, magnetic parameters, flow parameters, ionizing, radiation, subatomic particles, photons, pressure, force, density, heat, temperature, and proximity or presence.

As previously described, the indicators 20 are interconnected with each other over a mesh network to the access gateway 300. The access gateway 300 is connected to the remote server 500 over a network, preferably a wired network The wired network in combination with the mesh network formed by the nodes 350 and the access gateway 300 allows vacancy related information and other information obtained by the sensors mounted on each of the indicators 20A to 20K to be transmitted from the indicators 20 to the processing module remote server 500. Each of the indicators 20 can communicate their vacancy status to the server 500 and any other devices 60 inter-connected to the server 500 in real-time by sending data packets or signals over the network. In other embodiments, the access gateway 300 may be connected to the remote server 500 over a wireless network.

The server 500 processes the data received from the indicators 20A to 20K and uses standard internet protocols for sending processed data (or enhanced data) to computing devices 60 in communication with the server 500 via an Application Program Interface (API). The remotely located computing devices 60 may receive the processed information from the server 500 over the internet network. As a result, a live vacancy status can be viewed on applications running on the remotely located display devices 60 such as a mobile phone, desktop computer, tablets or virtual reality headsets. As a result remotely located persons such as emergency personnel operating such remotely located computing devices 60 are able to receive real time updates relating to vacancy of the one or more areas.

The server 500 also enables remotely located users to set the status of the indicators 20 as previously described. Specifically, a remotely located computing device 60 with an input means (such as a keyboard) may be used by remotely located persons for entering control information for setting or triggering the initialised status of the indicators 20A to 20K. In a typical initialisation step carried out from a remote location, a user can enter a command on the setting device 60 and send the command in the form of data packets or signals to the server 500 over the internet. The server 500 subsequently processes the control information and transmits status setting instructions in the form of data packets to the indicators 20A to 20K. As a result, the system 1000 advantageously allows the remotely located persons to set or activate the status of the indicators 20A to 20K.

In some further embodiments, the information received from the indicators 20 may be overlaid with additional information at the server 500. Subsequently, the server 500 processes the overlaid information for generating useful and meaningful data such as building maps and exit pathways based on real time feedback. The server 500 transmits the generated data to the remotely located displaying devices 60 for viewing by the remotely located persons. In an exemplary embodiment, the vacancy related information may be overlaid with pre-programmed mapping information. Such processing of information would be helpful in generating maps indicating vacancy status of different areas of a building being evacuated. The remotely located computing devices 60 also processing capacity and some of the vacancy related is processed by the remotely located computing devices. In at least some embodiments, the server 500 is also useful for generating analytical data based on the vacancy related information received by the server 500.

The vacancy related information and other information received and processed by the server 500 and the remotely located devices 60 may also be stored on storage means such as cloud based data storage devices. The storage of the information allows retrieval of the information at a later date for purposes such as preparing reports or audits relating to an emergency situation. The stored information may also be processed for generating predictive information.

In the preferred embodiment, the indicators 20 may be provided in the form of a ‘thin client’ with limited data processing ability. It is expected that a substantial part of the data processing is not likely to occur at the indicator 20. Instead, most of the data processing is likely to occur at the server 500 and/or at the remotely located devices 60. “Thin client” devices are inexpensive and improve scalability and ease of executing software update across the system 1000.

Advantageously, the indicators 20 are inter-connected with each for over the mesh network for exchanging information over the mesh network. Inter-connecting the indicators 20 also provides multiple data transmission pathways for transferring information between the indicators 20A to 20K and the server 500. For example, if one of the direct network pathways between the indicators 20A to 20K and the server 500 becomes dysfunctional, the vacancy related information may be transmitted over the mesh network to an adjacent indicator 20A to 20K and that information is subsequently transmitted to the processing module via an alternative network path.

The block diagram in FIG. 1 relates to evacuating a building during an emergency situation. However, in alternative embodiments, the occupancy or vacancy indicating system and method may also be useful for a partial or complete lockdown of a space such as a building without departing from the spirit and scope of the invention.

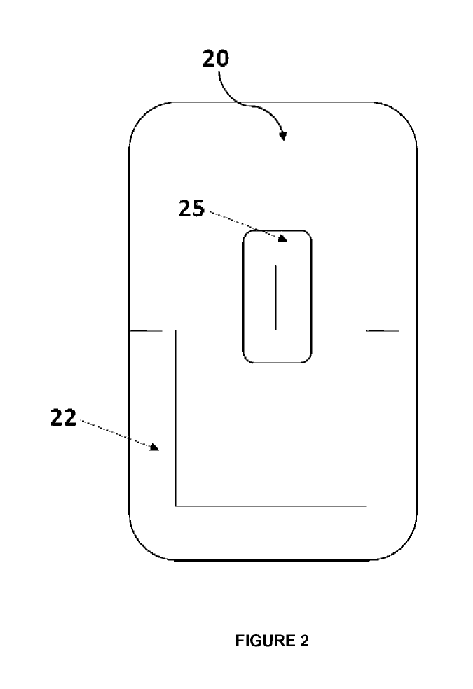

In the presently described embodiment, the indicator 20 as shown in FIG. 2 comprises indicators in the form of LED lights 22 as previously described. However, in alternative embodiments, audible or tactile indicating means may also be provided to denote the status of the indicator 20 without departing from the spirit and scope of the invention.

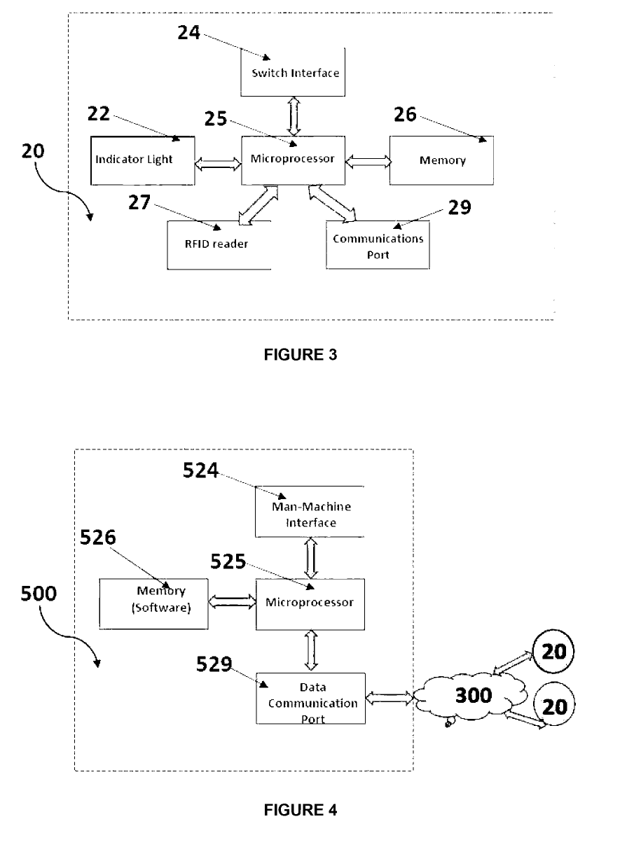

Referring particularly to FIGS. 2 and 3, each of the indicators 20 are provided with a printed circuit board having a microcontroller 25 and a memory 26 that can be mounted on a first side of the printed circuit board a data communications port 29 for communication with the microcontroller 25 for establishing a connection with an access gateway. Memory 26 can be any suitable non-volatile memory and the microcontroller 25 can include an analogue-to-digital converter and a transmitter, along with processing and other suitable circuitry. The transmitter can be, e.g., an RF (radio frequency) transmitter, and/or can be based on BLE (Bluetooth low energy) or ANT wireless technologies. Alternatively, any suitable transmission technology can be used. In some embodiments, the microcontroller can be Part No. nRF51822 manufactured by Nordic Semiconductor ASA of Oslo, Norway, or an equivalent part. The nRF51822 is a Cortex-m0 System-on-Chip with integrated 2.4 GHz radio peripheral that may be used as the main controller and also function as transceiver. In the preferred embodiment, the microcontroller may communicate with sensing means provided in the form of a Grove-125KHz RFID Reader 27 through a Universal Asynchronous Receiver Transmitter (UART). Indicators in the form of LED drivers for driving LED lights 22 provided on the indicators 20 are provided for indicating various occupancy states. As illustrated in FIG. 2, the LED lights are adapted for indicating various colours, each colour being indicative of a vacancy or occupancy status. A low dropout linear regulator may be provided for sourcing power from a rechargeable 3.7V lithium cell to supply energy to the LED lights and the microcontroller. Each indicator 20 also includes a downwardly directed reflector and lens that assists with directing light, emitted by the LED, in a generally downward direction. The intensity and colour of the LED may also be adjusted. Each of the indicators 20 comprises a radio transceiver capable of communicating with one or more of other indicators 20 located in a given area forming a part of the mesh network. One or more of the indicators 20 may share the same network ID and may therefore be adapted to share information such as vacancy or occupancy status. Each of the radio nodes 350 may also be used for passing information or instructions for setting occupancy or vacancy status of the indicator 20. It will share information about its status and pass along any messages coming from the gateway node. The wireless network connecting the nodes 350 may operate in the 2.4 GHz band region and may be organised as a broadcasting mesh. By way of example, in one exemplary embodiment to indicators may 70 may be interconnected in the mesh network. The gateway 300 also communicates with the server 500 through a wired connection in order to update the node status. Bi directional data pipes may be used for exchanging information between the indicators 20 in the mesh network or between the indicators 20 and the remote server 500.

The server 500 comprises a processor 525, a computer readable memory 526 in communication with the processor 525 and a data communications port 529. The computer readable memory 526 comprises executable instructions to establish a connection for transmission of data between the data communications port and the remotely located access gateway 300 and communicate with the remotely located microcontrollers 25 of the indicators 20 by transmitting data packets, the microcontrollers 25 being in communication with the gateway 300. The instructions also involve checking for a response from the gateway 300, the response being in relation to a status recorded by a sensor in communication with the remotely located microcontrollers 25; and transmit data packets from the data communications port 529 to the microcontrollers 25 upon receiving the response.

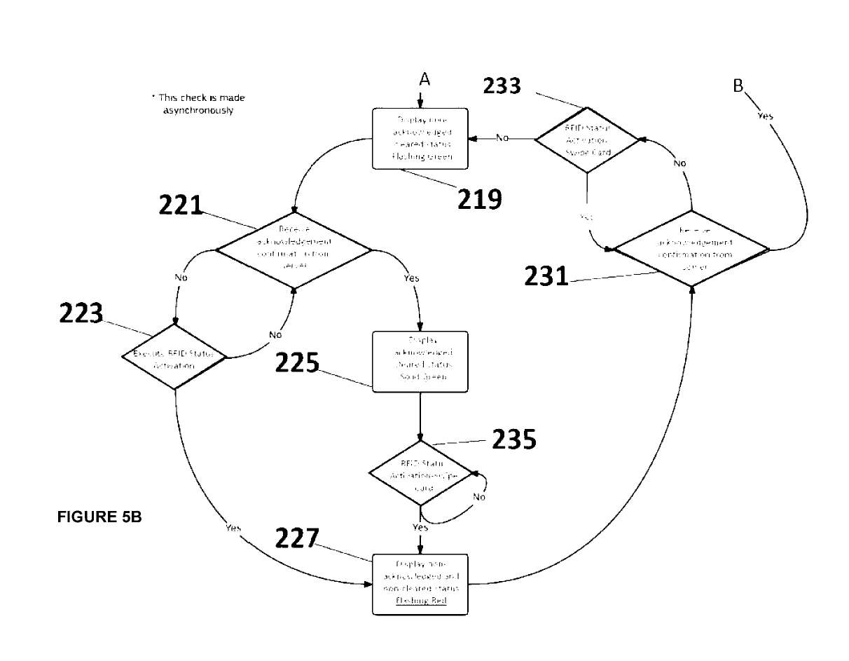

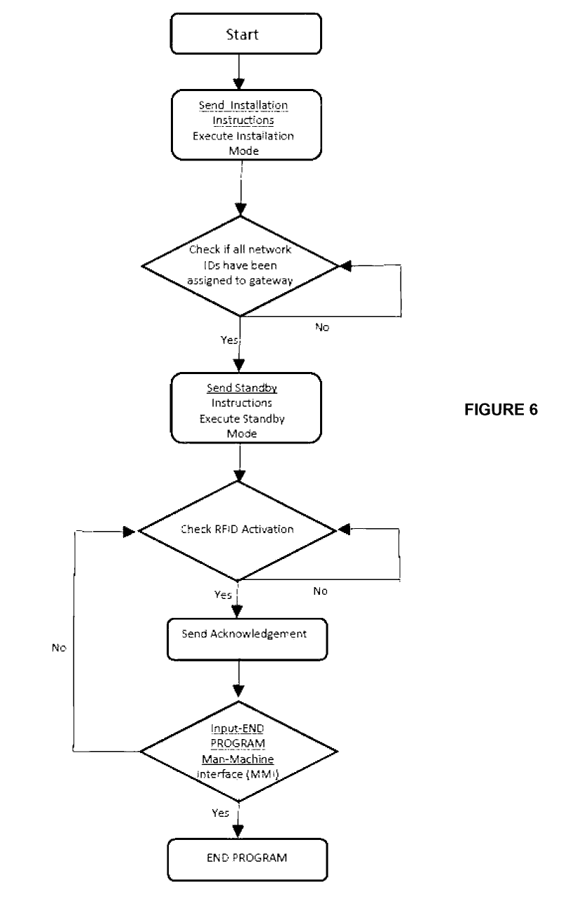

Referring to FIGS. 5A, 5B and 6, flowcharts for the operation of the indicators 20 and the remote server 500, in order to execute an exemplary embodiment in accordance with the present invention, are illustrated. The method 200, as executed by the indicator involves an initial installation step that requires an installation mode to be triggered on each of the indicators 20. During the initial installation step, the memory 526 in the remotely located server 500 sends data packets through the data communication port 529 to the gateway 300 which in turn directs the data packets to the nodes 350 in communication with each of the indicators 20. As a result, an indication module 20 receives instructions for executing an initial installation mode of operation in an initial installation step 205. The triggering of the installation mode in the indicator 20 may be accompanied by a visual indication of the installation mode in the form an LED indicator emitting a blue light.

Operational parameters stored on the memory 26 provided in the indicator 20 may include a Gateway ID assigned by the gateway 300 in a network ID assignment step 215 undertaken by the indicators. The gateway ID is the operational Network ID of the logical group of indicators 20 to which gateway 300 belongs and an address of the remotely located Web server 500 which may be, for example, an IP address. In other embodiments, the address of Web server 500 may also be stored on a wireline module. It may be safely assumed that if an indicator 20 is using a Network ID that matches the gateway's Network ID then that indicator 20 is a member of the gateway's logical communication group. The network ID assignment may be repeated until all the indicators 20 have been assigned network IDs by the gateway 300. The memory 26 in the indicators 20 may be pre-programed such that once a network ID has been assigned by the gateway 300, each of the indicators 20 becomes operational and commences operation in a standby mode. It is important to appreciate that maintaining a low power mode for the indicators 20 is advantageous for reducing the overall power consumption of the indicators 20 during periods when an emergency situation has not arisen.

Once the standby mode is triggered, the indicators 20 become ready for routine operation. In an event of an emergency, an emergency initialisation step 210 for initialising indicators 20 located at separate areas or zones of a building may be triggered by the gateway 300. Specifically, the remotely located server 500 sends data packets (via the data communications port 529 and the gateway 300) to each of the indicators 20. The indicators 20 receive the data packets through the communications port 29 and execute an Emergency state in the indicators 20 that form part of the network associated with the gateway 300. The initialising step 210 may be carried out during an emergency situation that requires evacuation of the building. In the present embodiment, the initialisation step 210 is triggered remotely. Once the initialisation state in the indicator 20 is triggered, the user may optionally undertake a colour assignment step 212 assign a colour for the LED indicator lights 22 in order to assign a specific colour when the initialisation state is triggered by the remotely located server 500. Once the emergency state is triggered by the initialisation step, the LED indicator lights 22 in the indicators 20, the indicators 22 may display a solid blue light indicating the initialised emergency status for the indicator 20 in the initialised state 214. The solid blue light provides an indication that an emergency situation has been triggered.

Once the emergency state in the indication modules 20 has been triggered, an authorised personnel (such as a fire warden) may check an area associated with each of the indicators 20 and once the area has been cleared or vacated, the person may use an RFID card for activating the RFID sensor by a swiping action on the RFID sensor provided on the indicator 20 by way of swiping an RFID tag resulting in swipe activation (denoted by step 217) of the indicator 20. Once the RFID card has been swiped, the indicator 20 executes an intermittent status step 219 by displaying a flashing green light (on the indictors 22) that indicates an intermittent cleared status for the area associated with the relevant indicator 20. The setting of the intermittent cleared status of the indicator 20 by the swipe activation 217 results in a signal being sent (via the data communications port 29 and the gateway 300) to the memory 526 of the remotely located server 500. As previously discussed, data packets are transmitted to the memory 526 of the server by the data communication port 529 and the memory 526 is pre-programmed in the present embodiment to receive the data packet associated with the swipe activation and in response send an acknowledgement data packet back to the memory 26 of the indicator 20. In this manner, the server 500 may acknowledge receipt of the signal by sending a confirmatory signal back to the indicator 20 by way of executing an acknowledgement step. The indicator 20, upon receiving the confirmatory signal in an acknowledgement receiving step 221, the indicator 20 may display a solid green colour on the LED indicator lights 22 thereby displaying a confirmed cleared status 225 on the indicator 20. It is important to appreciate that providing a visual indicator that confirms that the occupancy or vacancy status of the area assigned to the relevant indicator 20 has not only been checked or cleared but that the occupancy or vacancy status has also been recorded or acknowledged by the remotely located server 500 provides a significant advantage during execution of the method 200.

In an alternative scenario in which the remotely located server 500 fails to acknowledge receipt of the signal upon swiping of the RFID card, the user or the fire warden may need to once again swipe the RFID card in an additional swiping to execute another swiping action resulting in an additional swipe activation 223 at the indicator 20 until the remotely located server 500 acknowledges receipt of the additional swiping signal (in the form of data packets) sent from the indicator 20 to the remote server 500. As discussed earlier, the remote server 500 receives the swiping signals and sends back a confirmatory signal back to the indicator 20.

During an emergency or evacuation operation, the user or the fire warden may identify an area which has not been cleared. In such a scenario, the user or the fire warden may toggle the status of the indicator 20 from a cleared status (green-solid-225) to an intermediate non-cleared state 227 (denoted by flashing red) by once again swiping the RFID card that results in swipe activation 235 of the indicator 20 to operate and display a second status, namely a non-cleared status denoted by a red indicator light. The additional swiping step is also followed by an acknowledgement step that requires the change in occupancy or vacancy status (triggered by the swiping step) to be acknowledged by the remotely located server 500 in a manner as previously described. Once the change in the occupancy or vacancy status is acknowledged by the remotely located server 500 by the acknowledgement step, the indicator 20 displays a confirmed non-clear status (shown in solid red). Once again, if the remotely located server 500 fails to acknowledge receipt of the signal upon swiping of the RFID card, the user or the fire warden may need to once again swipe the RFID card in an additional swiping step 223 until the remotely located server acknowledges receipt of the signal and sends back a confirmatory signal. The gateway 300 may also optionally reset the network state by way of a resetting step 242. The resetting step may be carried in an asynchronous manner.

As discussed above, the gateway 300 is responsible for communicating changes in the nodes emergency statuses and other relevant information, such as network ID, battery level and local temperature (and possibly RSSI). The gateway 300 also triggers and halts the emergency status when required by the remote server 500. Both data and queries are transferred through the gateway UART port. The gateway will autonomously stream information from the nodes as they are updated.

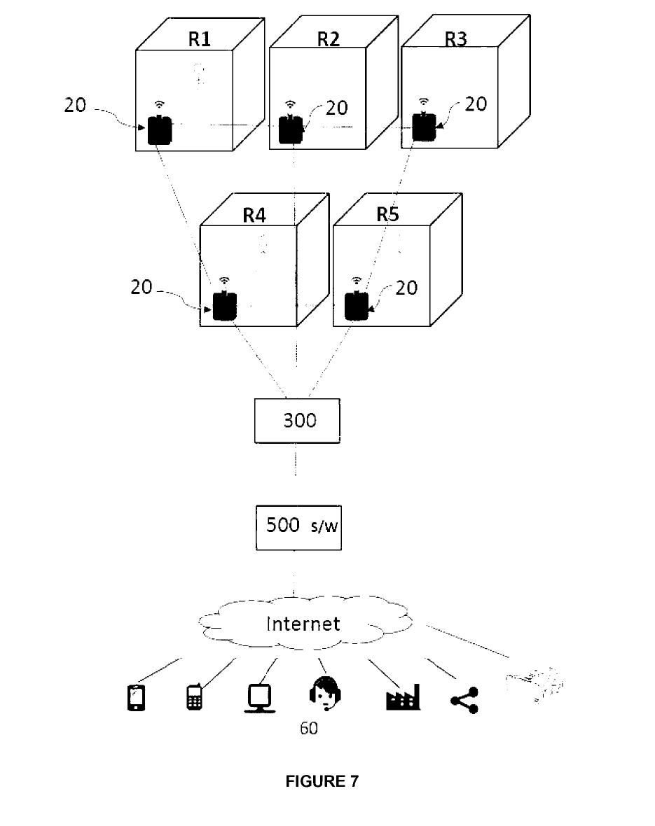

FIG. 7 depicts an in-use diagram of the vacancy indicating system 1000. Like reference numerals depict like features that have been previously described in the earlier sections. Specifically, a plurality of inter-connected indicators 20 are mounted in discrete sections, namely rooms R1, R2, R3, R4 and R5. Specifically, a separate indicator 20 is installed at an entrance of each of the rooms R1 to R5. Alternatively, the indicator 20 may be positioned in several zones in a building or a public venue or a building complex. By way of example, a pre-determined number of indicators 20 may be positioned in each zone of the building or venue or complex. In the specific example depicted in FIG. 7, rooms R1, R4 and R5 are occupied by occupants (represented by stick figures) and rooms R2 and R3.

In an emergency scenario, an initialisation or activation of the indicators 20 may be triggered from a remote location by an authorised personnel such as the chief fire warden of a building.

In an exemplary scenario, the chief warden may use a mobile computing device 60 with a user input interface for receiving initialisation instructions from the chief warden in the scenario. The server 500 connected to the computing device 60 receives the initialisation input and processes the input to provide the processed information or signal to the server 500. The server 500 receives the initialisation instructions from the device 60 and further processes the instructions to transmit data packets with processed initialisation instructions to the indicators 20 in the rooms R1 to R5.

The indicators 20, upon receiving the initialisation instructions, process the instructions and this step triggers the LED drivers driving the LED indicator lights in each of the indicators 20. Upon receiving the initialisation instructions, the indicators on the indicators 20 display a solid amber coloured light which indicates an activated or initialised state. During use, the display of the activated or initialised state on the indicators 20 prompts floor wardens for an area comprising rooms R1 to R5 to physically inspect the occupancy or vacancy of each of the rooms R1 to R5. During the inspection, the floor warden may discover that rooms R1, R4 and R5 have not been evacuated whereas rooms R2 and R3 have been vacated by the occupants. Upon observing the occupancy status of the rooms, the floor warden may use their authorised RFID tag to transmit this vacancy related information to each of the indicators 20. By way of example, in rooms R1, R4 and R5, the floor warden may use their RFID tag to trigger an occupied state in the indicators 20 mounted at the entrance of rooms R1, R4 and R5.

The indicators 20 located at rooms R1, R4 and R5, upon receiving the occupancy related activation from the floor warden, display flashing red lights in the indicators 20. Subsequently, the indicators for rooms R1, R4 and R5 also transmit the occupancy related information to the server 500 in a manner as previously described. The server 500 acknowledges the receipt of the occupancy related information from the indicators for rooms R1, R4 and R5 and sends confirmatory signal or data packets back to the indicators R1, R4 and R5. Upon receiving the confirmatory signal from the server 500, the indicators for the rooms R1, R4 and R5 process the confirmatory signal and display a solid red light indicating an acknowledged occupancy state.

The indicators 20 located at rooms R2 and R3, upon receiving the occupancy related activation from the floor warden, display flashing green lights in the indicators 20. Subsequently, the indicators for rooms R2 and R3 also transmit the occupancy related information to the server 500 in a manner as previously described. The server 500 acknowledges the receipt of the occupancy related information from the indicators for rooms R2 and R3 and sends confirmatory signal or data packets back to the indicators for the rooms R2 and R3. Upon receiving the confirmatory signal from the server 500, the indicators for the rooms R2 and R3 process the confirmatory signal and display a solid green light indicating an acknowledged another occupancy state.

A plurality of devices 60 may be connected to the server 500 over the internet for controlling the operation of the indicators 20 in a manner as previously described.

The network switches between 3 possible operation modes. The states are switched given the conditions specified in the operation flowchart. When first turned on, the network devices get in “Installation mode” until a Network ID is assigned to them by the gateway. After that, the network will switch to standby mode remaining in low power mode. In the event of an emergency triggered by the gateway 300, the nodes are set in “emergency state” until a RFID card is swiped. The indicator 20 will then turn into non-acknowledged cleared or not cleared mode until the acknowledgement by the server 500.

### Mesh Operation Internals

All Information transmitted within the mesh is received by all the nodes 350. In order to provide some node addressability, the messages are sent through pipes and each node 350 is associated to an incoming and an outgoing pipe after a network ID has been assigned to it. The first pair of pipes is used for broadcasting messages and they should be used for address assignment purposes and to define the network addresses as well.

The communication between the nodes 350 is only possible when the nodes 350 use the same network address. For this reason, it is recommended to set this address during the manufacturing process.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment.

Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An occupancy or vacancy indicating system comprising:
an indicating assembly comprising a controller and an indicator to indicate an occupancy or vacancy related status of one or more areas of a space; the controller being arranged to set the status of the indicator;
a receiver for receiving one or more signals from a remotely located device, the receiver being in communication with the controller to initialise the indicating assembly to thereby indicate an activated status in response to receiving one or more signals from the remotely located device; and
a sensor positioned in close proximity to the indicating assembly, the sensor being in communication with the controller to modify the activated status of the indicator upon sensing occupancy or vacancy of the one or more areas of the space and display a corresponding occupancy or vacancy related status wherein the controller is arranged to modify said statuses of the indicator only after receiving the one or more signals from the remotely located device.

2. An occupancy or vacancy indicating system in accordance with claim 1 wherein the sensor is adapted to sense occupancy or vacancy as provided by users present in the one or more areas of the space.

3. An occupancy or vacancy indicating system in accordance with claim 1 wherein the sensor comprises a Radio Frequency Identification (RFID) sensor.

4. An occupancy or vacancy indicating system in accordance with claim 1 wherein the indicator is operable to indicate a first status and a second status such that that the controller is adapted for switching the indicating module between the first status and the second status in response to the sensing of the indication of occupancy or vacancy.

5. An occupancy or vacancy indicating system in accordance with claim 1 wherein the remotely located device comprises a user input interface to receive user input from a remotely located user to initialise the indicator from a remote location.

6. An occupancy or vacancy indicating system in accordance with claim 1 further comprising a processor for receiving information relating to occupancy or vacancy of the one or more areas from a plurality of the indicating assemblies over a network and processing the information for display at a remote location by preferably overlaying processed information with additional information.

7. An occupancy or vacancy indicating system in accordance with claim 1 wherein the system comprises:
a central access gateway; and
one or more radio nodes adapted for connecting one or more indicating assemblies located near the one or more nodes,
wherein the radio nodes are connected to the access gateway across the network and the gateway is adapted for transmitting signal to the controller for setting the status of the indicating modules connected to said one or more nodes.

8. An occupancy or vacancy indicating system in accordance with claim 7 wherein each one or more of the indicating assemblies comprises a respective Wi-Fi enabled device having a unique MAC address associated with each of the indicating assemblies for establishing an Internet Protocol (IP) connection with the gateway and wherein the access gateway is preferably connected to remotely located server, the access gateway being adapted for receiving controlling instructions from the server for controlling the indicators.

9. An occupancy or vacancy indicating system in accordance with claim 8 wherein the processor is configured to run a module stored in a memory, the module being configured to establish an IP connection between the gateway and said one or more nodes across the network, the node being configured to wirelessly connect with the Wi-Fi devices for allowing transmission of data between the indicating modules and the gateway.

10. An occupancy or vacancy indicating system in accordance with claim 9 wherein the module is configured to establish an IP connection between the gateway and said one or more nodes across the network by identifying the MAC address associated with the Wi-Fi devices and associating each of the Wi-Fi devices with one or more corresponding nodes.

11. An occupancy or vacancy indicating system in accordance with claim 9 wherein the processor is programmed such that, during use, indicator displays a first visual indicia in response to sensing an indication of occupancy or vacancy as received from a user in the area, transmitting information relating to the indication to the gateway and/or the server and wherein the indicator displays a second visual indicia in response to receiving confirmation of the transmission of the indication to the gateway and/or server.

17. An occupancy or vacancy indicating system in accordance with any one of claims 1 wherein the indicator displays a first visual indicia in response to the sensor sensing an indication of occupancy or vacancy by a user in the one or more areas, the system comprising a transmitter to transmit information relating to occupancy or vacancy to a remote location upon sensing the indication at the sensor, and displaying a second visual indicia at the indicator in response to receiving confirmation of the transmission of the indication to the remote location.

13. An occupancy or vacancy indicating method comprising the steps of:
initialising an indicating assembly from a remote location to display an activated status on an indicator of the indicating assembly by transmitting a signal from the remote location to the indicating assembly;
sensing occupancy or vacancy of one or more areas of a space by with a sensor in the one or more areas by activating the sensor after the activated status has been displayed by the indicator;
controlling the indicator of the initialised indicating assembly to modify the activated status of the indicator in response to the sensor sensing the occupancy or vacancy in the one or more areas; and
displaying an occupancy or vacancy related status corresponding to the occupancy or vacancy sensed by the sensor only after receiving the one or more signals from the remotely located device.

14. An occupancy or vacancy indicating method in accordance with claim 13 further comprising the step of controlling the indicator of the initialised indicating assembly by switching the status displayed by the indicator from at least a first status relating to occupancy or vacancy of a user in the one or more areas to at least a second status relating to occupancy or vacancy of the user in the one or more areas.

15. An occupancy or vacancy indicating method in accordance with claims 13 comprising the step of receiving and processing occupancy or vacancy related information from the one or more indicating modules and preferably displaying processed information on a display device, the displaying device being preferably located at a remote location.

16. An occupancy or vacancy indicating method in accordance with any one of claims 13 further comprising:
establishing, by an access gateway, an Internet Protocol (IP) connection between a plurality of nodes, across a network and the gateway, said nodes adapted for connecting with one or more indicating assemblies located near said one or more nodes; and
controlling the status indicated by indicators of the indicating assemblies connected to said one or more nodes by transmitting one or more signals from the gateway to said one or more nodes.

17. An occupancy or vacancy indicating method in accordance with claim 16 wherein each one or more of the indicating assemblies further comprises a Wi-Fi enabled device having a unique MAC address, the method further comprising the step of associating each one or more of the Wi-Fi enabled devices with one or more of the indicating assemblies and establishing an Internet Protocol (IP) connection with the gateway.

18. An occupancy or vacancy indicating method in accordance with claims 16 further comprising the steps of:
connecting the access gateway to a server, preferably a remotely located server, and
transmitting instructions from the server to the access gateway, the instructions being provided for controlling the indicators of the indicating assemblies.

19. An occupancy or vacancy indicating method in accordance with claim 16 wherein the method further comprises the steps of:
displaying a first visual indicia at the indicator of the indicating assembly in response to the sensor sensing occupancy of vacancy of a user in the one or more areas,
transmitting information relating to the occupancy or vacancy, as sensed by the sensor, to the gateway and/or the server; and
displaying a second visual indicia at the indicator of the indicating assembly in response to receiving confirmation of the transmission of the indication to the gateway and/or server.

20. A device for indicating an occupancy or vacancy status of a designated area, the device comprising:
a microcontroller, a memory accessible by the microcontroller and a data port assembly in communication with the microcontroller for establishing a connection with an access gateway, the memory including executable instructions for operating the microcontroller in an activated mode upon receiving an activation signal from the access gateway;
a switching device in communication with the microcontroller for switching the status of the activated microcontroller in between at least a first occupancy or vacancy status and a second occupancy or vacancy status only when the microcontroller has been activated by the activation signal; and
one or more indicators in communication with the microcontroller and switching device wherein the one or more indicators indicate an activated status upon activation of the microcontroller and wherein the activated status displayed by the one or more indicators is modified by the switching device to indicate said at least first and/or second status only after the microcontroller has been activated.

21. A computer server for implementing an occupancy or vacancy indicating system; the server comprising:
a processor;
a computer readable medium in communication with the processor;
a data communications port,
wherein the computer readable medium comprises executable instructions to:
establish a connection for transmission of data between the data communications port and a remotely located access gateway and communicate with a remotely located microcontroller by transmitting data packets, said microcontroller being in communication with the gateway to become activated upon receiving activation instructions from the computer readable medium;
check for a response from the gateway only after the microcontroller has been activated upon receiving the activation instructions, the response being in relation to a status recorded by a sensor in communication with the remotely located microcontroller; and
transmit data packets from the data communications port to the microcontroller upon receiving the response.
